(19) United States
(12) Patent Application Publication
(10) Pub. No.: US 2017/0346961 A1
(43) Pub. Date: Nov. 30, 2017

(54) MODIFIED DOCUMENT GENERATION

(71) Applicant: Hewlett-Packard Development Company, L.P., Houston, TX (US)

(72) Inventors: Ashok Kopparthi, Bangalore (IN); Prasannajit Tripathy, Bangalore (IN)

(21) Appl. No.: 15/516,069

(22) PCT Filed: Dec. 1, 2014
(86) PCT No.: PCT/US2014/067954

§ 371 Date: Mar. 31, 2017

(30) Foreign Application Priority Data
Oct. 4, 2014 (IN) 4981/CHE/2014

(51) Int. Cl. H04N 1/00; H04N 1/034; H04N 1/195

(52) U.S. Cl. CPC H04N 1/00331; H04N 1/19568; H04N 1/00336; H04N 1/034

(57) ABSTRACT

Example implementations disclosed herein includes techniques for devices, systems, and methods for a multifunction device for generating modified documents based on a physical document comprising images and text. The modified documents are generated according to arrangements that exclude the images or the text.

### BACKGROUND

Printers deposit ink toner on media to, generate physical copies of document data. Scanners can optically detect the content of physical documents to generate corresponding document data. Multifunction printers include functionality for printing and scanning, as well as faxing, and copying.

### BRIEF DESCRIPTION OF THE DRAWINGS

FIG. 1 is a schematic of a multifunction device that includes content selection capabilities, according to various examples of the present disclosure.

FIG. 2 illustrates an example of a text-only modified document, according to an example of the present disclosure.

FIG. 3 illustrates an example of an image only modified document, according to an example of the present disclosure.

FIG. 4 illustrates an example of a separated text and image modified document, according to an example of the present disclosure.

FIG. 5 illustrates an example of a text with image reference modified document, according to an example of the present disclosure.

FIG. 6 depicts a dataflow for generating a modified document, according to various examples of the present disclosure.

FIG. 7 is a flowchart of a method for generating a modified document, according to various examples of the present disclosure.

### DETAILED DESCRIPTION

When a physical document is reproduced using a copier or multifunction printer, all of the content in the document are captured and reproduced. Reproduction or printing requires the consumption of various printing materials, such as paper and ink/toner. Depending on the type of printing materials and the printing technique used, document reproduction can be expensive. For example, making many duplicate copies of documents with many pages of text or that include images (e.g., graphics, photos, icons, etc.), may be undesirable because of the cost of the consumable printing materials. This is especially true when reproducing color images. Various example implementations described herein include techniques for systems, devices, and methods for generating modified documents that selectively include, exclude, and/or rearrange the text and images contained in an original physical or electronic document. The modified documents can include only the text of the original document, only the images of the original document, the images and the text of the original documents separated into separate modified documents, or text with references to the images that are rendered on a separate page of the modified document. For example, examples of the present disclosure can be implemented as content selection module implemented as software or firmware in a multifunction printer with optical character recognition (OCR) capabilities. Accordingly, a user may scan a physical original document and select to print out only the text of that document using only the multifunction printer.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

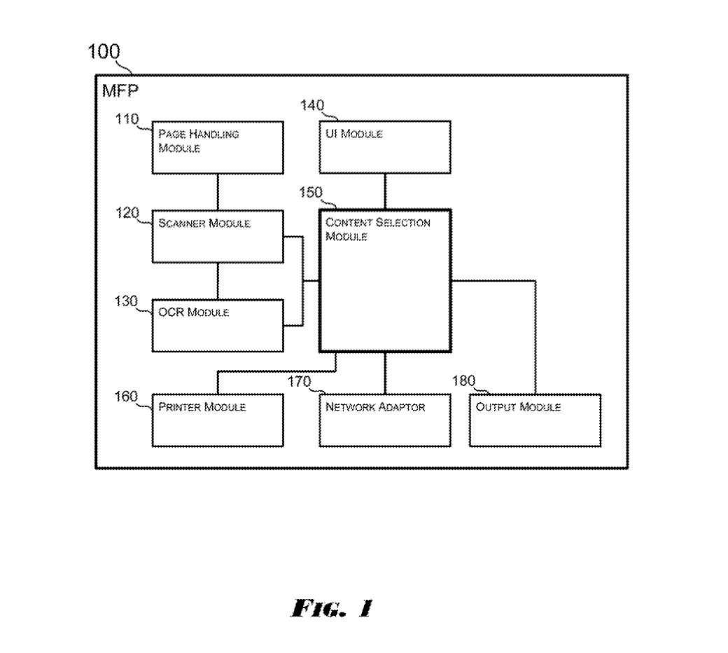

FIG. 1 is a schematic of multifunction printer system 100, according to various examples of the present disclosure. The multifunction printer system 100 can include subsystems or devices having various types of functionality. One example of the multifunction printer system 100 can include scan, print, copy, and fax capabilities. Accordingly, multifunction printer system 100 can include combinations of hardware, firmware, and software for implementing the various functions. For the sake of clarity and brevity, the functionality of the multifunction printer system 100 are discussed herein in reference to its component modules. Multifunction printer system 100 may be implemented by at least one computing device and may include at least modules 110, 120, 130, 140, 150, 160, 170 and 180, which may be any combination of hardware and programming to implement the functionalities of the modules described herein. For instance, the functionality of the various component modules of the multifunction printer system 100 may be implemented as computer executable code or code segments stored in a non-transitory computer readable storage medium and executed in one or more processors or controllers. In other examples, the functionality of the various component modules may be implemented in one or more application-specific integrated circuits (ASICs). In yet other examples, the functionality of the various component modules may be implemented as computer executable code stored in a non-transitory computer readable storage medium and executed on a processor of a computer system.

The example implementation of the multifunction printer 100 depicted in FIG. 1 can include page handling module 110, a scanner module 120, an optical character recognition (OCR) module 130, a user interface (UI) module 140, a content selection module 150, a printer module 160, a network adapter 170, and an output module 180. The functionality of the various component modules of the multifunction printer 100 can all be controlled by a central processor or controller (not shown) and are described in detail below.

In various implementations, the functionality of the component modules of the multifunction printer 100 can be initiated by user input entered through the UI module 140. Accordingly, the UI module 140 can include user interface control elements, such as buttons, touchscreens, dials, and the like, to control the functionality of the multifunction printer 100. In one example implementation, the UI module 140 can include a graphical user interface (GUI) that presents the user with a number of virtual buttons for interacting with the multifunction printer 100. Such virtual buttons can include controls for initiating a scan, a copy, a fax, performing OCR functions, entering settings, and the like. For instance, a user may select a “scan” function of the multifunction printer 100 to capture an image of original physical document as document data. Similarly, the user may select a “copy” function of the multifunction printer 100 to generate additional physical copies of the original document. Accordingly, when a user initiates particular functional of the multifunction printer 100, the various component modules can work in conjunction with one another to achieve the desired result.

For instance, the page handling module 110 can include various types of paper handling mechanisms. In one example, the page handling module 110 can include an automatic document feeder (ADF) that includes a sheet feeder for scanning multiple documents across the photosensitive elements of a scan head of the scanner module 120 one document (e.g., page) at a time. In other example implementations, the page handling module 110 can also include a glass platen on which documents can be placed and a scan head carrier. In such implementations, a scan head of the scanner module 120 on one side of the platen can scan the document on the other side of the platen by moving the scan head carrier from one end of the platen to the other. Both ADF and platen glass implementations of the page handling module 110 work in conjunction with the scanner module 120 to scan a particular physical document to generate document data corresponding to the contents of the document. In such implementations, the document data usually includes images, such as a JPEG, TIF, bitmap, or the like, of the text and images contained in the original document.

The resulting document data can then be converted to an appropriate file format and transmitted to a computing device over the network adapter 170 (e.g. a wired or wireless network card, or a USB interface, etc.), or output to a computer readable medium, such as a hard drive, flash drive, or the like, through the output module 180. Accordingly, generating a scanned copy of the original document may require the functionality of the page handling module 110, the scanner module 120, the network adapter 170, and/or the output module 180.

Generating physical copies of the original document may also require use of the printer module 160. In such implementations, in response to user input received to the UI module 170 invoking a copy functional, the page handling module 110 and the scanner module 120 can work in conjunction as described above in reference to the scan functionality of the multifunction printer 100 but, instead of outputting an electronic version of the scanned copy of the original document, the printer module 160 can generate hardcopies of the original document using one or more print techniques. Such printing techniques can deposit ink or toner on various types of media, such as paper, card stock, transparencies, and the like. In such embodiments, the printer module 160 can include any printer technology, such as inkjet print technologies, electrophotographic technologies (e.g. xerographic, laser, LED, etc.), and the like.

In various examples, the multifunction printer 100 can also include the OCR module 130. OCR module 130 can include functionality for analyzing the images of the text and images in the document data to recognize individual letters, numbers, characters, words, and/or phrases to generate corresponding text data. The text data can include any machine-readable code that universally describes corresponding letters, numbers, characters, words, and/or phrases according to a particular coding scheme. For example, many of the letters, numbers, and characters typically used in Western languages can be rest presented in, the American standard code for international interchange (ASCII) has unique 7-bit binary integers. In other embodiments, letters, numbers, and characters can be encoded using other binary schemes as well as hexadecimal schemes.

Text data differs from image data in that text data can be used to infer meaning or values distinct from the visual representation of that data. Image data on the other hand, can include the computer readable code that describes the specific configuration of individual pixels that make an image. The image data but has no underlying meaning distinct from the image that is formed when the image data is rendered as a graphic on a computer display or printer.

In other examples of the present disclosure, the multifunction printer 100 can include a content selection module 150 coupled to and/or in communication with the other modules FIG. 1 depicts a particular configuration in which the content selection module 150 is directly coupled to the UI module 140, the scanner module 120, the OCR module 130, as well as the printer module 160, the network adapter 170, and the output module 180. In other examples, the functionality of the content selection module 150 may be included in one or more of the other modules, such as the scanner module 120 and/or the OCR module 130.

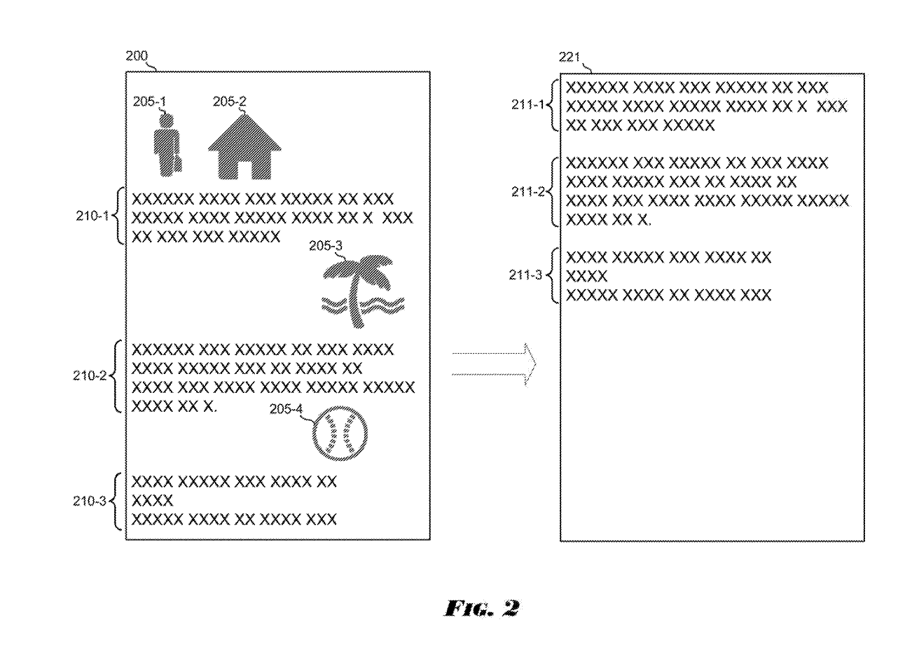

In one example implementation, the content selection module 150 can receive user input through the UI module 140 to generate a modified copy of an original document based on the corresponding document data by separating the text and the images. In some examples, the modified copy can include only the text of the original document. In other examples, the modified copy may include only the images from the original document. In yet other examples, the modified copy may include the text and the images separated from one another on one or more separate pages. In related examples, the modified copy may include all the text from the original document grouped together and include cross-references and/or placeholders corresponding to the location of the images in the original document. The corresponding images and associated references can be reproduced separately in the modified copy. FIGS. 2 through 5 illustrates example variations of modified copies relative to original documents, according to various examples of the present disclosure.

FIG. 2 illustrates the modification of an original physical document 200 into a text-only modified document 221, according to a particular example of the present disclosure. The original document 200 can include any combination of images 205 and text 210 rendered on a physical medium (e.g., pictures and text on a printed page). In other examples, the original document 200 can include an image file comprising image data that when rendered depicts the images 205 and text 210 as images (e.g., a JPEG, PDF, TIF, etc.).

The images 205 can include various pictures, icons, symbols, graphics, and the like. In the particular example shown, image 205-1 is an icon of a man, image 205-2 is a symbol for a house, image 205-3 is a silhouette of a tree, and image 205-4 is a drawing of a baseball. Blocks of text 210-1 through 210-3 can include any combination of letters, words, numbers, characters, phrases, and the like. As shown, the images 205 and the text 210 on the original document 200 can be positioned relative to one another on the page according to a particular original arrangement. For instance, as shown in the original document 200 of FIGS. 2 through 5, images 205-1 and 205-2 are disposed above text 210-1. Image 205-3 is disposed on the page between text 210-1 and text 210-2 in a right-justified position. Image 205-4 is disposed between text 210-5 and text 210-3.

To generate the modified documents 221, the content section module 150 can invoke the functionality of the other modules of the multifunction printer 100. In some examples, the content selection module 150 can invoke the functionality of the page handling module 110, the scanner module 120, the OCR module 130, the printer module 160, and/or the output module 180. In response to command signals issued by the content selection module 150, the page handling module 110 and scanner module 120 can generate original document data corresponding to the original document 200. In such examples, the original document data can include image data that represents the visual representations of the images 205 and text 210. Once the original document data is generated, the content selection module 150 can instruct the OCR module 130 to perform one or more optical character recognition operations on the original document data to detect the text 210. Detection of the text 210 can include locating and recognizing individual letters, numbers, words, phrases, and/or characters in the text 210 and encoding it using one or more coding schemes, such as ASCII, binary, hexadecimal, or the like. The encoded text can then be saved as corresponding text data, as described herein.

Any portions of the original document data not recognized as text can be assumed to include an image and saved as image data. Accordingly, the portions of the original document data that include images only can be isolated using various pattern recognition and/or boundary determining techniques to generate corresponding image data. For example, the content selection module 150 can recognize image 205-1 as being distinct from image 205-2 and generate corresponding separate image data for each. The location of the text 210 and the images 205 in the original document 200 can be associated with the corresponding text data and image data.

In FIG. 2, the modified document 221 illustrates how the content selection module 150 can select to disregard the image data corresponding to the images 205 and only render text 211 based on the text data associated with the corresponding text 210. In such examples, the text 211 rendered in the modified document 221 can include an exact copy of the text 210. Content selection module 150 can replicate the original text 210 in the same size, format, font, and the like, such that the text 211 is represented exactly the same as text 210. In other examples, the content selection module 150 can render the text 211 differently than text 210 is rendered in the original document 200. The content selection module 150 can modify the size, color, font, format, and the like, such that the content and meaning of text 211 is the same as text 210 but with a different visual appearance.

Modification of the appearance of the text 211 from that of text 210 can advantageously enable modification of the density of the content. For example, by changing the particular font and/or the font size of the text 211, more of the text 210 can be fit on a single page, thus conserving paper and/or ink/toner when performing a paper-to-paper copying function. Similarly, when performing a paper-to-electronic copy function, the file size of the resulting electronic modified document 221 can be smaller if the image data is omitted, thus conserving data storage space.

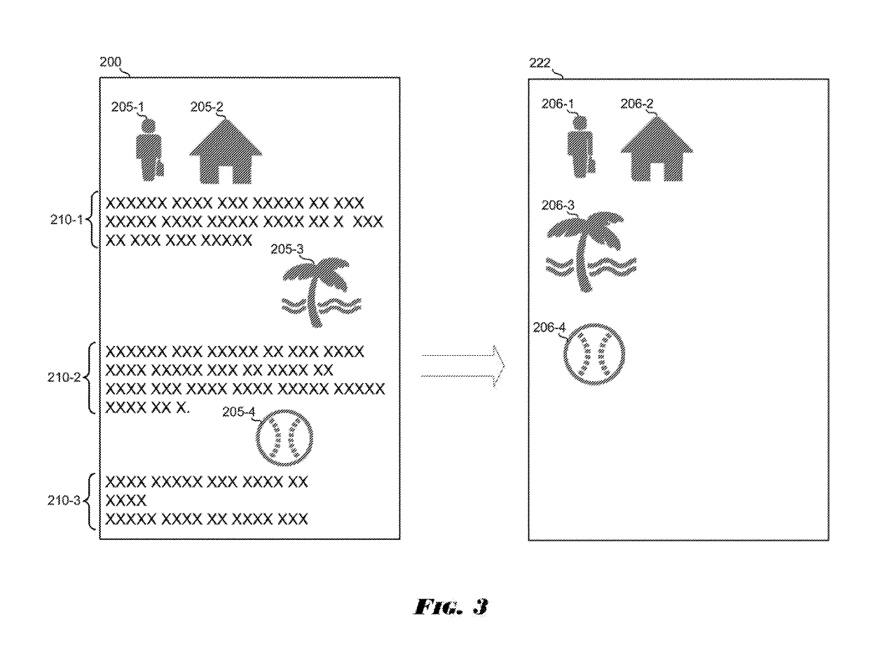

FIG. 3 illustrates another variation of a modified document 222. As shown, content selection module 150 can generate modified document 222 so that it only includes images 206 rendered based on image data corresponding to the images 205. In some examples, the images 206 in the modified document 222 can be exact duplicates of the images 205 in the original document 200. In other examples, images 206 can be changed with respect to size, color, positioning, order, orientation, and the like. For example, images 206 can be reduced in size so that all the images 205 from the original document 200 can fit on a single page or on a minimal number of pages of modified document 222.

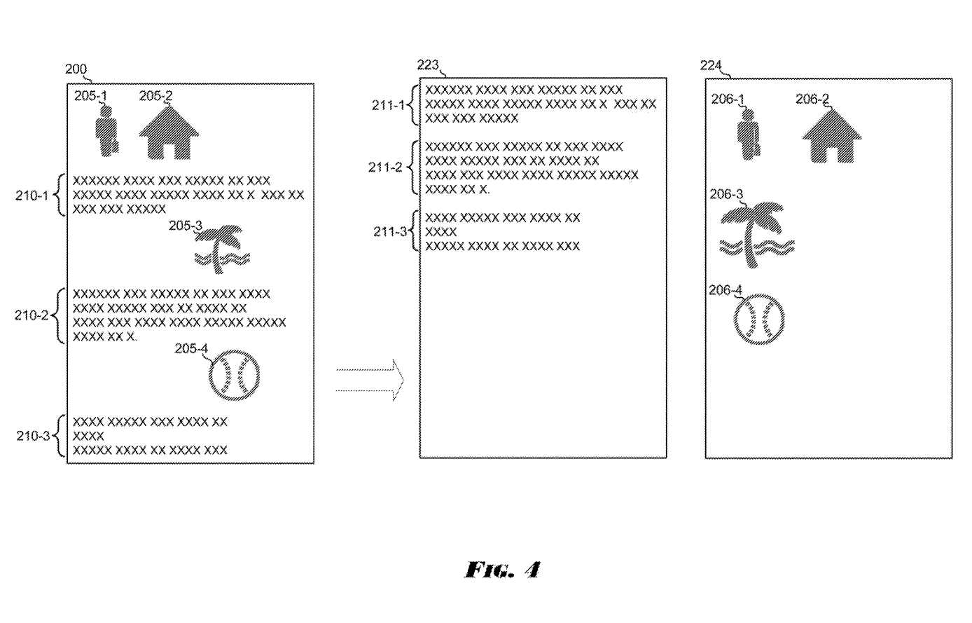

FIG. 4 illustrates another example of modified documents 223 and 224. In such examples, the images 205 and text 210 can be separated into separate pages of the resulting modified documents 223 and 224. For example, the text 211 corresponding to text 210 can be rendered on a first page as modified document 223 and the images 206 corresponding to images 205 of the original document can be rendered on another page as modified document 224. Modified documents 223 and 224 can advantageously include all of the text and images from the original document 200 but separated into individual pages of modified documents 223 and 224.

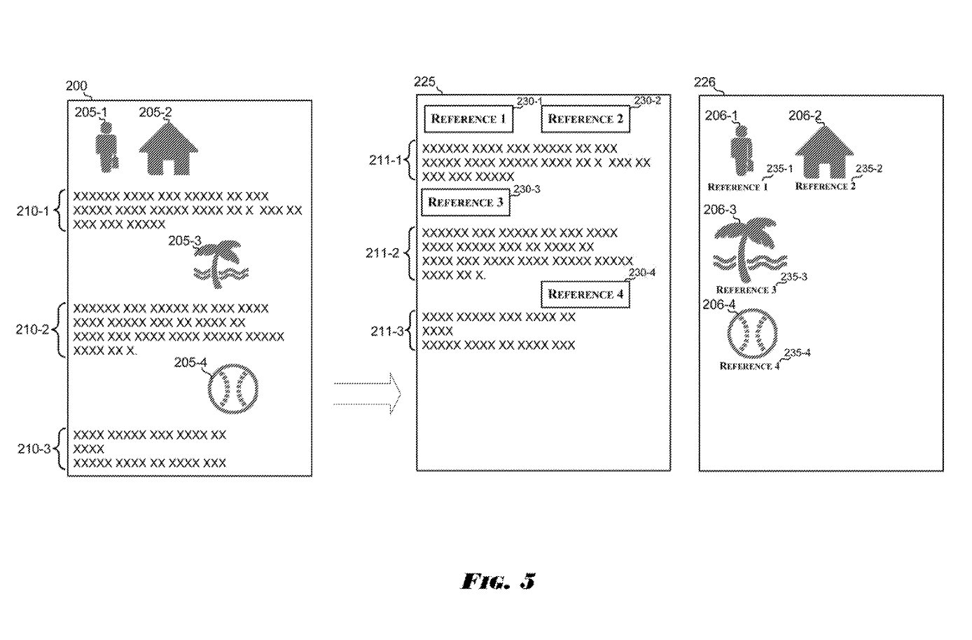

FIG. 5 illustrates yet another example of modified documents 225 and 226. In such examples, the modified document 225 can include text 211 and references to the relative or precise locations of the images 205 in the original document 200. For example, the modified document 225 can include placeholder references 230. The reference placeholders 230 can be disposed relative to the text 211 on the pages of the modified document 225 in positions analogous to the positions of the images 205 relative to the text 210 in the original document 200. Each of the reference placeholders 230 can include a reference number or identifier by which the corresponding images 206 in modified document 226 can be identified. For example, the reference placeholders 230 of modified document 225 correspond to reference numbers 235 in modified document 226.

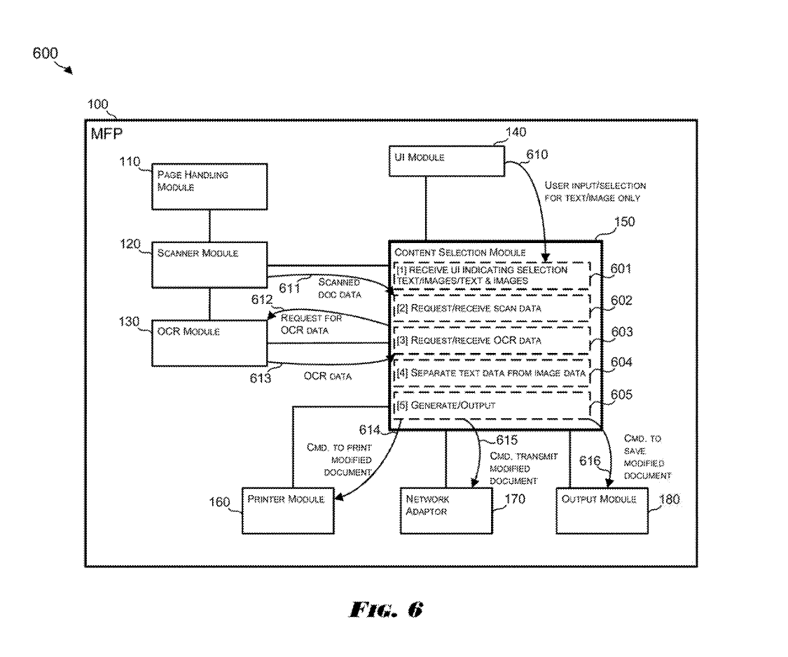

FIG. 6 illustrates a data flow 600 for generating modified documents containing selected content from an original document, according to an example of the present disclosure. In such examples, the content selection module 150 can receive the user input 610 from a user through the UI module 140 to indicate modification of an original document at 601 (reference 1). For example, the UI module 140 may display an option to modify an original document to produce a “text only” modified document (e.g., FIG. 2), an images only modified document (e.g., FIG. 3), a “separated text and images” modified document (e.g., FIG. 4), or a “text with image references” modified document (e.g., FIG. 5). A user may indicate a selection by pressing the appropriate physical or virtual button on the UI module 140. In addition, user input may also indicate the selection of output method. For example, the user may select to print the modified documents, send the modified documents to a computing device over a network, or save the modified documents to a local non-transitory memory or non-volatile storage device (e.g. a USB flash drive).

In response to user input 610, the content election module 150 can request and receive scanned document data 611 at 602 (reference 2). Accordingly, the content selection module 150 may issue a command to the scanner module 120 and/or the page handling module 110 to image an original physical document to generate corresponding document data using the corresponding scanning and page handling functionality. For example, the content selection module can request the scanner module 120 generate a PDF of the original single page document that the user has placed on the platen glass.

At 603, the content election module 150 can generate and send a request for OCR data 612 (reference 3) to the OCR module 130. In some examples, the request for OCR data generated by the content selection module 150 can include the scanned document data. In other examples, the OCR module 130 can obtain the scanned document data directly from the scanner module 120. In response to the request for OCR data, the OCR module 130 can analyze the document data to recognize text and generate corresponding text data. The OCR module 130 can combine the text data with image data and information about the arrangement of the text and images in the document data in OCR data 613. The OCR module 130 can then send the OCR data to the content selection module 150. As described herein, any information in the document data corresponding to the original document that is not recognized by the OCR module 130 as text, can be assumed to be an image and saved as corresponding image data. Information about the arrangement of the text and images in the original document can include absolute and relative positioning information.

At 604, the content selection module 150 can extract and separate the text data and image data from the OCR data 613 (reference 4). At 605, the content selection module 150 can generate and/or output a modified documents (reference 5) using the separated text data and image data in accordance with the user input 610. The arrangement of the text and/or images in the modified document may be different from the arrangements of the text and/or images in the original documents, as described above in reference to FIGS. 2 through 5.

Based on the user input indicating a selection of the type of modified document and the mode of output, the content selection module 150 can issue one or more commands to output the modified document. Such commands can include a command 614 to the printer module 160 to print the modified document, a command 615 to transmit the modified document to remote computing device through the network adapter 170, and/or a command 616 to save the modified document using output module 180 to a local memory device.

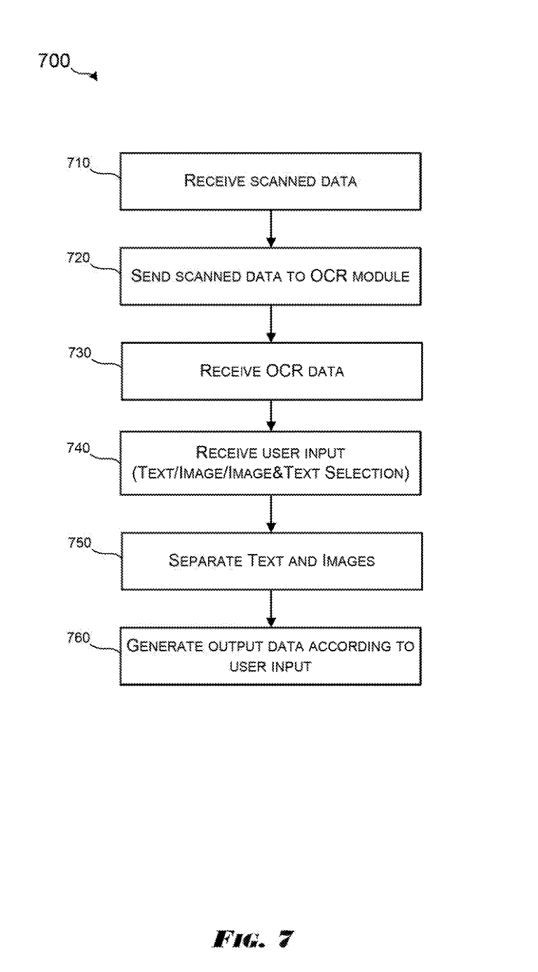

FIG. 7 is a flowchart of a method 700 for generating a modified document that includes the text, images, and/or text and images contained in an original physical document. The resulting modified document can be printed as a hard copy or saved as an electronic copy. Method 700 can be implemented as computer readable code or code segments executed by a processor in a multifunction printer 100 or other device with scanning and printing capabilities. Method 700 is described in reference to the functionality of a content selection module 150 implemented in a multifunction printer 100, the actions may also be performed by a general-purpose computer controlling one or more corresponding peripheral devices (e.g. a peripheral scanner and a peripheral printer).

At 710, the multifunction content selection module 150 can receive scanned data corresponding to an original document. The scanned original document data can include an image of the original document. At 720, the multifunction content selection module 150 can send the scanned original document data to an OCR module 130 implemented in the multifunction printer 100. In response to the scanned original document data, the content selection module 150 can receive corresponding OCR data, in which recognized text from the original document is represented by a particular coding scheme, at 730. The OCR data may also include image data corresponding to any content in the original document that could not be recognized as text.

At 740, the content selection module 150 can receive user input indicating a user's selection of a modified document. A selection for a modified document may include indications for “text-only”, “images only”, “separated images and text”, “text with image references”. Preference for modified documents may also include a selection of the output method, such as a printout, electronic file, and the like.

At 750, the content selection module 150 can separate the text and the images by separating the text data and the image data in the OCR data. At 760, the content selection module 150 can generate the output data according to the user input. Generating output data can include rendering a text file and/or an image file as the output data for the modified document. Based on the output data, the modified document can be printed or saved.

These and other variations, modifications, additions, and improvements may fall within the scope of the appended claims(s). As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

What is claimed is:

1. A device comprising:
a scanner module to scan a physical document comprising images and text to generate document data;
an optical character recognition module to recognize the text in the document data to generate text data corresponding to the text; and
a content selection module to generate image data corresponding to the images in the document data, and to generate modified document data excluding either the text data or the image data.

2. The device of claim 1, wherein the content selection module generates the image data by removing the text data from the document data.

3. The device of claim 1, further comprising a printer module to print an output physical document based on the modified document data.

4. The device of claim 1, wherein the content selection module generates the modified document data in response to user input indicating a selection of a modified document type that defines a modified arrangement of the modified document data different from an arrangement of the images and text in the physical document.

5. The device of claim 1, wherein the modified document data comprises an arrangement of the text and the images different from an original arrangement of the text and the images in the document data.

6. The device of claim 5, wherein the arrangement of the text and the images of the modified document data comprises cross references between the corresponding text and images.

7. The device of claim 1, further comprising an output module to output the modified document data as computer readable code in a particular file format.

8. A non-transitory storage medium comprising instructions executable by a processor, the instructions executable to:
scan a physical document to generate document data comprising text and images, wherein the document data comprises text data and image data corresponding to the text and images in the physical document;
generating an arrangement that excludes the text data or the image data and is different from an original arrangement of the text and the images in the physical document; and
outputting an output document in accordance with the arrangement.

9. The storage medium of claim 8, wherein outputting the output document comprises generating a command to print a physical version of the output document.

10. The storage medium of claim 8, wherein outputting the output document comprises generating a command to save an electronic version of the output document.

11. The storage medium of claim 8 wherein the arrangement excludes the text data.

12. The storage medium of claim 8 wherein the arrangement comprises a page comprising the image data.

13. The storage medium of claim 8 wherein the arrangement comprises a page comprising the text data.

14. A method comprising:
receiving document data corresponding to a scan of an original physical document comprising text and images;
sending the document data to an optical recognition module with a request for optical character recognition data;
receiving the optical character recognition data comprising image data and text data corresponding to the images and text of the original physical document;
receiving user input indicating a selection of a modified document type that defines a modified arrangement that excludes the text data or the image data on a single page and different from an arrangement of the text and images in the original physical document;
extracting the text data and the image data from the optical character recognition data; and
generating output data in accordance with the user input indicating the modified document type.

15. The method of claim 14, wherein generating the output data comprises printing a modified document according to the modified arrangement of the text data or the image data.
